(19) United States
(12) Patent Application Publication
(10) Pub. No.: US 2022/0240340 A1
(43) Pub. Date: Jul. 28, 2022

(54) USER EQUIPMENT AND METHOD FOR HANDLING COMMUNICATION ABNORMALITY OF USER EQUIPMENT

(71) Applicant: GUANGDONG OPPO MOBILE TELECOMMUNICATIONS CORP., LTD., Dongguan (CN)

(72) Inventors: Xin Xu, Palo Alto, CA (US); Yongsheng Shi, Palo Alto, CA (US)

(21) Appl. No.: 17/721,058

(22) Filed: Apr. 14, 2022

Related U.S. Application Data
(63) Continuation of application No. PCT/CN2020/124461, filed on Oct. 28, 2020.
(60) Provisional application No. 62/936,973, filed on Nov. 18, 2019.

(51) Int. Cl. H04W 76/19; H04W 24/08; H04W 24/10

(52) U.S. Cl. CPC H04W 76/19; H04W 84/042; H04W 24/10; H04W 24/08

(57) ABSTRACT

A method for handling communication abnormality of a user equipment (UE) and a UE are provided. The method includes: detecting, by a monitoring mechanism of the UE, a communication abnormality event; reporting the communication abnormality event together with attribute information of the communication abnormality event to a handling mechanism; handling, by the handling mechanism, the communication abnormality event; reporting, by the handling mechanism, the attribute information to a prevention mechanism for preventing the communication abnormality event from happening again, when a preset condition is met.

### CROSS-REFERENCE TO RELATED APPLICATION(S)

This application is a continuation of International Application No. PCT/CN2020/124461, filed Oct. 28, 2020, which claims priority of U.S. provisional application No. 62/936,973, filed Nov. 18, 2019, the disclosures of both of which are hereby incorporated by reference in their entireties.

### TECHNICAL FIELD

The present application relates to the field of electronic devices, and particularly to a method for handling communication abnormality of a user equipment (UE) and a UE.

### BACKGROUND

User Equipment (UE) such as cell phones is playing more and more important role in our daily life. People use UE to communicate with others through voice call, video call, SMS, and the like. People can also watch videos or browse internet through UE.

During communication with network or other external devices, there may be all kinds of issues which may impact the communication. Currently, when the issue occurs, the user has to retry communication manually, which is time consuming, complex, and generally cannot resolve the issue completely and successfully.

### SUMMARY

According to a first aspect of the disclosure, a method for handling communication abnormality of a user equipment (UE) is provided. The method includes: detecting, by a monitoring mechanism of the UE, a communication abnormality event; reporting the communication abnormality event together with attribute information of the communication abnormality event to a handling mechanism; handling, by the handling mechanism, the communication abnormality event; reporting, by the handling mechanism, the attribute information to a prevention mechanism for preventing the communication abnormality event from happening again, when a preset condition is met.

According to a second aspect, a UE is provided. The UE includes a detector, an abnormality processor, and a prevention controller. The detector is configured to detect a communication abnormality event and report the communication abnormality event, together with attribute information of the communication abnormality event, to the abnormality processor; the abnormality processor is configured to handle the communication abnormality event, and report the attribute information to the prevention controller when a preset condition is met; the prevention controller is configured to trigger a prevention action for preventing the communication abnormality event from happening again.

According to a third aspect of the disclosure, a non-transitory computer readable storage medium is provided. The computer readable storage medium stores a computer program which, when executed by a processor, causes the processor to perform the method of the first aspect.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic structural diagram of a user equipment (UE).

FIG. 2 is an abnormality detection and recovery framework according to embodiments.

FIG. 3 is a schematic structural diagram of a UE according to embodiments.

FIG. 4 is a schematic flow chart of a method for handling communication abnormality of a UE according to embodiments.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the invention.

When communicated with the network or external equipment, there are all kinds of issues UE can meet, which impact the functions of communication. Examples of the issues include but not limited to: (i) the UE is in an idle mode: out of service (00S), limited service, frequent service loss etc. (ii) Internet related: internet access not available, low throughput etc. (iii) call related: cannot make a call, cannot receive a call, or cannot send SMS etc.

Generally, the user who found the abnormal cases happened has few options to get rid of or recover from such abnormal cases. The user may (i) retry service attempt and see if the abnormal case can be recovered: in many cases, it will not success; (ii) wait for some time to retry: in many cases, it will not success; (iii) try to do some recovery, such as switching on the airplane mode first and then switching off the airplane mode: this operation is not well known to users and it may does not work in some cases; (iv) reset the device: during reset, the terminal device is not available and may impact usage of the user.

As can be seen, the options given above could not resolve the issues effectively and completely. All of the options need participation of the user, are low in successful rate, and are time consuming. Taking the above into consideration, it would be desirable to provide a novel solution for handling communication abnormality of a UE, which does not require enrolment of the user and can handle the communication abnormality at the UE side effectively.

According to embodiments of the disclosure, a proposal for handling communication abnormality of a UE is provided. Specifically, a method for handling communication abnormality of a UE and a UE for performing the method are provided. With aid of the technical solutions provided herein, it is possible to automatically detect and handle an abnormal case, and may further avoid the similar issue from happening again.

As used herein, the term “UE” refers to an electronic device with communication ability with a network. The term “communication” refers to data, information, or message transmission, reception, or exchange. The electronic device can include various handheld devices, on-board devices, wearable devices, computing devices or other devices with wireless communication function, other processing devices connected to wireless modems, as well as mobile stations (MS), mobile phones, personal digital assistant (PDA), terminal devices, and other handheld communication equipment.

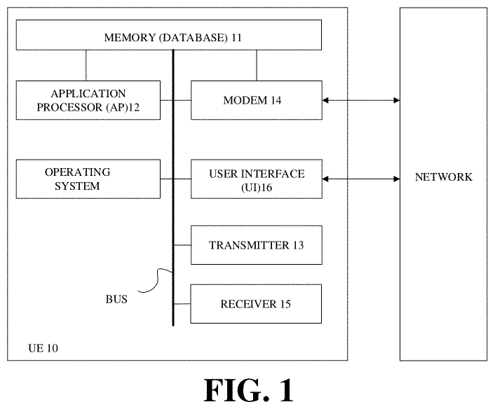

FIG. 1 is a schematic structural diagram of an exemplary UE. As illustrated in FIG. 1, UE 10 includes an application processor (AP) 12, a modem 14, and at least one user interface (UI) 16. All the UI related work and an operating system 18 running on the UE are supported by the AP 12. The operating system 18 can be a high level operating system (HLOS) such as Android/IOS. The modem 14 is the one behind to communicate with a network, that is, the UE communicates with the network via the modem.

The UE further includes a memory 11 for storing data or instructions. The data can be correspondence relationships, event related data, action related data, other data stored in a database, and the like, as detailed below. Instructions stored in the memory can be invoked by the AP 12 to achieve certain functions, such as abnormality detection and recovery.

The UE may further include a transmitter 13 and a receiver 15. The transmitter 13 is configured to transmit data to the network. The receiver 15 is configured to receive data from the network. The transmitter 13 and the receiver 15 can be integrated into a transceiver. The term “data” as used herein can be text, voice, video, image, codes, signals, signaling, and the like.

The AP 12, the modem 14, the UI 16, the memory 11, the transmitter 13, and the receiver 15 can be coupled and communicated with each other via a bus.

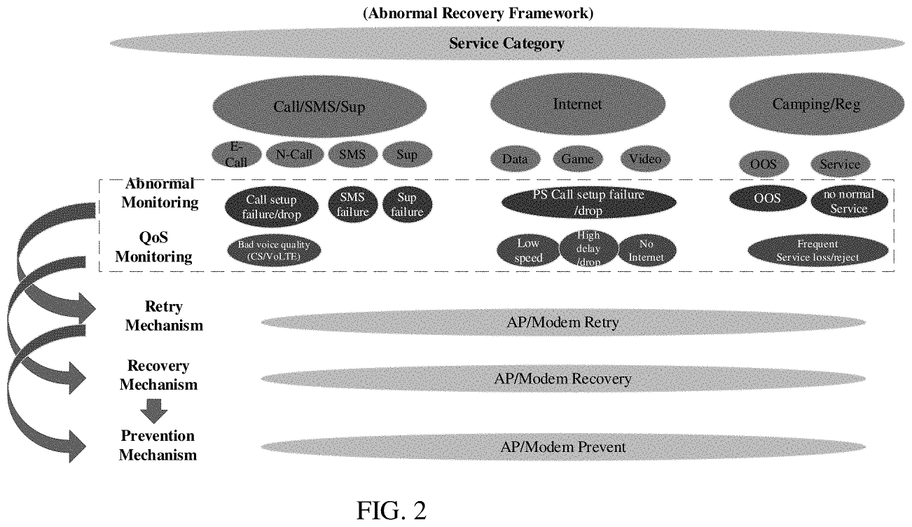

FIG. 2 is an abnormality detection and recovery framework according to embodiments.

The whole proposal (framework) for handling communication abnormality of a UE includes a monitoring mechanism, a handling mechanism, and a prevention mechanism. As illustrated in FIG. 2, the monitoring mechanism is for detecting communication abnormality events and includes: (i) abnormality monitoring for service failure event (to detect erroneous or abnormal situation); (ii) QoS Monitoring for low QoS event (to detect low QoS). The handling mechanism is for handling communication abnormality events and includes: (1) a retry mechanism (to allow service success); (2) a recovery mechanism (to get back to normal state). The prevention mechanism is triggered to avoid the situation from happening again.

With the framework provided herein, it is possible to automatically detect an abnormal case before user notices in some scenarios, and to achieve intelligently retry and levelled recovery, such that the UE can recover silently in lowest cost. Furthermore, for certain network related issues (like faulty cells), the proposed framework will allow UE to avoid the similar issue from happening again by lowering the priority of those cells or not camping on those cells in future for example. As such, the above mechanisms will work together to achieve abnormality detection, retry/recovery to normal state, as well as abnormality prevention.

As illustrated in FIG. 2, the service category that the technical solutions provided herein deal with at least relates to: (i) call such as emergency call (E-Call) and normal call (N-Call)/short message service (SMS)/supplemental service (Sup) such as call forwarding/call waiting etc.; (ii) Internet service such as data, game, and video; (iii) camping/registration (Reg) such as 00S and other services. Abnormality detection and recovery for each service category will be detailed below with reference to FIG. 2.

Call/SMS/Sup

As illustrated in FIG. 2, in terms of Call/SMS/Sup, the service failure event includes but not limited to: call setup failure/drop, SMS failure, and Sup failure. The low QoS event detected for example relates to bad voice quality.

Internet

As further illustrated in FIG. 2, in terms of Internet, the service failure event includes packet switch (PS) call setup failure/drop. The low QoS event detected can be low speed, high delay/drop, and the like.

Camping/Reg

As further illustrated in FIG. 2, in terms of Camping/Reg, when there is no moral service, it can be determined that there is a service failure event, and when there is frequent service loss or reject, it can be determined that the low QoS event occurs.

To handle a service failure event detected, a retry mechanism will be triggered. Similarly, to handle a low QoS event detected, a recovery mechanism will be triggered. As an embodiment, as can be seen from the bottom of FIG. 2, a prevention mechanism can be further triggered by the handling mechanism according to the result of handling.

Each of the monitoring mechanism, handling mechanism, and the prevention mechanism can be achieved through software, hardware, or a combination of software or hardware. In one embodiment, the monitoring mechanism, handling mechanism, and the prevention mechanism can be achieved at the modem 14. In another embodiment, the monitoring mechanism, handling mechanism, and the prevention mechanism can be achieved at the AP 12. In still another embodiment, the monitoring mechanism can be achieved at the modem 14, while the handling mechanism and the prevention mechanism can be achieved at the AP 12.

As one example, the monitoring mechanism is integrated into the AP 12 illustrated in FIG. 1, in this case, communication abnormality monitoring or detecting is done by the AP. However, when the monitoring is performed by the AP 12, there may be a delay from when a communication abnormality event occurs to when the communication abnormality event is actually detected by the AP 12. On the other hand, since chips from different manufactures are used in mobile phones, taking the compatibility and adaptability of different chips into consideration, when the monitoring is performed at the AP 12, compared with when the monitoring is performed at the modem 14, it is more conducive to maintenance of the UE and the system thereof.

To address the above delay issue, the monitoring mechanism can be integrated into the modem 14 to allow the modem 14 to detect communication abnormality. Compared with the AP 12, the modem 14 can make faster response to the communication abnormality event and can obtain more event related data, however, the modem 14 is simple in function and has limited storage compared with the AP 12 and therefore, it may be difficult for the modem 14 to store massive information.

For the handling mechanism such as the retry mechanism, it can be integrated into the modem 14. Since the modem 14 itself has a retry mechanism, integrate the retry mechanism into the modem 14 can be cost saving and simple in design. On the other hand, if the retry mechanism is implemented at the AP 12, the degree of freedom and flexibility in retry can be improved. For instance, in case of voice call setup failure (0x00003 as illustrated in Table 3), when multiple SIM cards are installed in the UE, if the retry mechanism is triggered by the AP 12, the AP 12 can send a retry request to the modem 14 together with an ID of a SIM card through which re-dial is conducted. The SIM card used for re-dial may be the same or different from that used for the previous failed voice call. However, still use the above situation as an example, if the retry mechanism is triggered by the modem 14, the modem 14 will use exactly the same SIM card as the previous failed voice call to re-dail, which may result in low success rate in re-dail.

To be summarized, whether each of the monitoring mechanism, the handling mechanism, and the prevention mechanism is achieved at the AP 12 or the modem 14 can be determined according to the effect to be pursued and is not restricted herein. Obviously, part or all of the monitoring mechanism, the handling mechanism, and the prevention mechanism can also be achieved at other suitable hardware components of the UE.

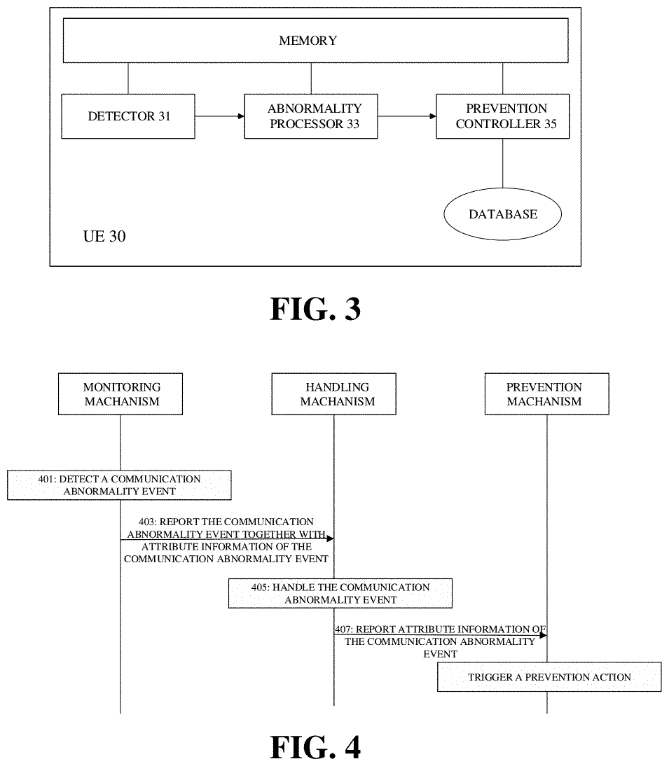

Based on the framework of FIG. 2, a UE is provided. FIG. 3 is a schematic block diagram illustrating the UE. As illustrated in FIG. 3, UE 30 includes a detector 31, an abnormality processor 33, and a prevention controller 35. The detector 31 is coupled with the abnormality processor 33 and is configured to detect a communication abnormality event and report the communication abnormality event, together with attribute information of the communication abnormality event, to the abnormality processor 33. The abnormality processor 33 is coupled with the prevention controller 35 and is configured to handle the communication abnormality event, and report the attribute information to the prevention controller 35 when a preset condition is met. The “preset condition” referred to herein is: the abnormality processor 33 fails to handle the communication abnormality event and the communication abnormality event occurs more than a preset number of times during a preset period. The prevention controller 35 is configured to trigger a prevention action for preventing the communication abnormality event from happening again.

The detector 31 is the hardware implementation for the monitoring mechanism of FIG. 2, and can be integrated into the AP 12 or the modem 14 of FIG. 1. The abnormality processor 33 is the hardware implementation for the handling mechanism of FIG. 2, and can be integrated into the AP 12 or the modem 14 of FIG. 1. Similarly, the prevention controller 35 is the hardware implementation for the prevention mechanism, and can be integrated into the AP 12 or the modem 14 of FIG. 1. Alternatively, the detector 31, the abnormality processor 33, and the prevention controller 35 can be set separately and connect with each other via a bus for example. One example is that, the detector 31 is integrated into the modem 14 of FIG. 1, the abnormality processor and the prevention controller are integrated into the AP 12 of FIG. 1.

The detector 31 is further configured to: determine an event ID corresponding to the communication abnormality event according to a correspondence relationship between communication abnormality events and event IDs, where each communication abnormality event has one unique event ID. When the event ID of the communication abnormality event is determined, the detector 31 can report the event ID to the abnormality processor. Correspondingly, when the event ID is received at the abnormality processor 33, the abnormality processor 33 determines an action corresponding to the event ID according to a correspondence relationship between event IDs and actions, and triggers the action thus determined to handle the communication abnormality event.

The “attribute information” referred to herein includes cell related information. The “cell related information” in turn includes at least one of: cell ID, a radio access technology (RAT) currently used, and a public land mobile network (PLMN) currently communicated with, and so on.

The prevention controller 35 is configured to trigger at least one of the following prevention actions: the cell ID is added to a low priority cell list or blacklist, the RAT currently used is temporally disabled, and the PLMN currently communicated with is temporally disabled. The prevention action is released when a timer corresponding to the prevention action expired or when a location relating to the cell related information is changed.

In one embodiment, the attribute information may further include at least one of time and location information of the communication abnormality event.

The detector 31 is configured to report the communication abnormality event to the abnormality processor 33 on condition that the communication abnormality event lasts for a preset time period. Alternatively or additionally, the detector 31 is configured to report the communication abnormality event to the abnormality processor 33 on condition that the communication abnormality event occurs more than a preset number of times.

The communication abnormality event includes at a service failure event and a low QoS event. When the communication abnormality event reported by the detector 31 is the service failure event, the abnormality processor 33 is configured to adopt a retry mechanism to handle the service failure event, in the retry mechanism, a retry action corresponding to the service failure event is triggered to allow the UE have communication service successfully. When the communication abnormality event reported by the detector 31 is the low QoS event, the abnormality processor 33 is configured to adopt a recovery mechanism to handle the low QoS event, in the recovery mechanism, a recovery action corresponding to the low QoS event is triggered to allow the UE to get back to a normal QoS state.

The detector 31, the abnormality processor 33, and the prevention controller 35 may share a common memory or each have a memory for storing data such as the correspondence relationship between the events and event IDs, the correspondence relationship between events, event IDs, retry/recover actions or between event IDs and retry/recover actions, and other prevention action related data.

Based on the framework of FIG. 2, a method for handling communication abnormality of a UE is provided. The method can be performed by the UE illustrated in FIG. 3. As another option, the method can be implemented in the UE illustrated in FIG. 1. FIG. 4 is a flow chart illustrating the method for handling communication abnormality.

As illustrated in FIG. 4, the method includes the following operations.

At block 401, a monitoring mechanism of the UE detects a communication abnormality event. The monitoring mechanism can be implemented as the detector 31 of FIG. 3.

At block 403, the monitoring mechanism reports the communication abnormality event together with attribute information of the communication abnormality event to a handling mechanism. For instance, the monitoring mechanism can send a request or instruction to the handling mechanism, and in response to the request or instruction received, the handling mechanism can determine and trigger a corresponding action to handle the communication abnormality event. The attribute information includes cell related information. The cell related information includes at least one of: cell ID, a radio access technology (RAT) currently used, and a public land mobile network (PLMN) currently communicated with.

At block 405, the handling mechanism handles the communication abnormality event. The handling mechanism can be implemented as the abnormality processor 33 of FIG. 3.

At block 407, the handling mechanism reports the attribute information to a prevention mechanism for preventing the communication abnormality event from happening again, when a preset condition is met. Under the prevention mechanism, certain prevention action is triggered to prevent the same event from happening again. The prevention mechanism can be implemented as the prevention controller 35 of FIG. 3.

In one embodiment, the attribute information may further include at least one of time and location information of the communication abnormality event. With aid of the time and/or location information of the communication abnormality event, the prevention mechanism can determine the time or location change of the UE, and then determine whether to release the prevention action that has been triggered.

The monitoring mechanism includes abnormality monitoring (also known as service failure monitoring) and QoS monitoring (also known as low QoS event monitoring). The communication abnormality event at least includes a service failure event and a low QoS event.

Abnormality Monitoring is used to detect abnormal situation in every service category. QoS Monitoring is used to detect QoS degradation in each service category. The abnormality monitoring will provide an indication to the retry mechanism, and the QoS Monitoring will provide an indication to the recovery mechanism.

In an embodiment, a correspondence relationship between events and events IDs are maintained in advance, where each event has a unique ID. The method further includes: determining an event ID corresponding to the communication abnormality event according to a correspondence relationship between communication abnormality events and event IDs, where each communication abnormality event has one unique event ID. With the event ID is introduced herein, when reporting the communication abnormality event to the handling mechanism at block 403, the event ID can be reported.

In terms of the reporting at block 403, the reporting can be done per a preset rule. The preset rule may be time, counter, or threshold related. For example, the communication abnormality event is reported to the handling mechanism on condition that the communication abnormality event lasts for a preset time period. Still another example, the communication abnormality event is reported to the handling mechanism on condition that the communication abnormality event occurs more than a preset number of times.

Based on the above, operations at block 401 and block 403, which relates to communication abnormality event monitoring and reporting, will now be described in detail for service failure event and low QoS event respectively.

Abnormality Monitoring for Service Failure Event

A table of key events related with UE abnormal service can be defined as below in Table 1 with some examples.

TABLE 1

| | Event ID | Abnormality Event (Service failure event) Name |
|---|---|---|
| 1 | 0x00001 | Cellar Service Lost (no signal) |
| 2 | 0x00002 | Couldn't get normal service (network registration |
| | | failed/rejected) |
| 3 | 0x00003 | Voice call setup failure |
| 4 | 0x00004 | Data call setup failure |
| 5 | 0x00005 | Voice call drop |
| 6 | 0x00006 | Data call drop |
| 7 | 0x00007 | SMS (text) sending failure |
| 8 | 0x00008 | Supplemental service failure |

UE, specifically, the monitoring mechanism disposed at the AP 12 or Modem 14 of FIG. 1, shall be able to detect the defined events and translate the event detected into EVENT ID to be reported to the handling mechanism for handling. In one embodiment, the UE will translate the event detected into EVENT ID along with attribute information such as time/location/network/RAT (GSM/WCDMA/LTE etc.). The time/location/network/RAT (GSM/WCDMA/LTE etc.) is the attribute information of the event.

For example, in case UE Modem detects an event of Limited Service on 14:25:30, UE can translate it to Event ID 0x0002 with camped PLMN/Cell ID. Similarly, if modem reports an event of voice call setup failure, UE can translate it to Event ID 0x0003.

Rule (Time/Counter/Threshold) for Service Failure Event Reporting

Optionally, as mentioned above, certain rules can be defined for an event on how/when it will be reported to the retry mechanism. The rules can be time or counter based. All defined events may follow the same rule or each event may have a specific rule. For example, data call service may have a rule different than voice call service.

Time: After specified time past, if the service failure event related abnormal situation remains, then report it; otherwise report it right away if no other conditions are defined.

Counter/Threshold: Each time the service failure event is detected, increase the counter for the event, if the value of the counter is equal to or larger than a threshold corresponding to the event, then report the service failure event. Otherwise report the service failure event every time the event is detected if no other conditions are defined.

For instance, the threshold can be set to 5, 10, or any other suitable values. Each time the service failure event is detected, the counter for the event will be increased by 1, where the initial value of the counter is 0. In case the threshold is 5, the service failure event will be reported only when it has been occurred for 5 times, that is, when the value of the counter reaches 5.

Time and counter/threshold: Each time the service failure event is detected, increase the counter for the event, if the value of the counter reaches a threshold corresponding to the event within a preset time period, then report the service failure event. Otherwise report the service failure event every time the event is detected if no other conditions are defined.

As such, the reporting takes the randomicity of events into consideration. For example, due to mobility of UE, when the UE moves out of coverage of a cell, a service failure event may occur. However, the service failure event will be disappeared immediately after the UE moves back into the coverage of the cell. In this situation, there is no need to report the service failure event at the first occurrence thereof and such instantaneous service failure event can be ignored. However, if the service failure event last for a long time or occurs several times, it indicates that such service failure event is not an accidental event and needs to be reported to be handled.

QoS Monitoring for Low QoS Event

A table of key events related with UE QoS can be defined as below with some examples.

TABLE 2

| | Event ID | Low (poor) QoS Event Name |
|---|---|---|
| 1 | 0x10001 | CS voice call poor quality |
| 2 | 0x10002 | PS voice call poor quality |
| 3 | 0x10003 | Data call low throughput |
| 4 | 0x10004 | Data call long delay |
| 5 | 0x10005 | Data call big jitter |
| 6 | 0x10006 | Frequent service lost |
| 7 | 0x10007 | Frequent network scanning |

UE can define a list of QoS Rules for each major service and use it to trigger a low QoS event. The major service referred to herein incudes but not limited to CS voice call, PS voice call, data call throughput/delay/jitter, service lost frequency, network scanning frequency, and the like.

For example, one rule specifies that in case the data call throughput is less than x Kb/s, UE can declare a low QoS event. “x” can be a fixed value or based on the radio access technology (RAT) UE is used (like for 2G, “x” may be smaller and for LTE, “x” will be a larger value). In case UE detects data throughput lower than x KB/s, according to Table 2, the UE can trigger the QoS event corresponding to event ID 0x10003.

Rule (Time/Counter/Threshold) for Low QoS Event Reporting

Similar to service failure event reporting, certain rules based on time and/or counter/threshold can be defined for a low QoS event on how/when it will be reported to the recovery mechanism.

Time: After specified time past, if a low QoS event remains, then report the event, else report the event right away if no other conditions are defined.

Counter/Threshold: Each time a low QoS event is triggered, increase the counter thereof. If the value of the counter is equal to larger than a threshold corresponding to the low QoS event, then report the low QoS event. Otherwise, report the low QoS event each time the event is detected if no other conditions are defined.

Time and counter/threshold: Each time a low QoS event is detected, increase the counter for the event, if the value of the counter reaches a threshold corresponding to the event within a preset time period, then report the service failure event. Otherwise report the service failure event every time the event is detected if no other conditions are defined.

At block 405, the handling mechanism is invoked to handle the communication abnormality event. Corresponding to the communication abnormality event which includes the service failure event and the low QoS event, the handling mechanism includes a retry mechanism for handling the service failure event and a recovery mechanism for handling the low QoS event.

As mentioned above, the abnormality monitoring mechanism for service failure event provides an indication to the retry mechanism, and the QoS monitoring mechanism for low QoS event provides an indication to the recovery Mechanism. After such indication is received at the handling mechanism, the retry mechanism would provide actions to retry the service relating to the service failure event, such as a call request; the recovery mechanism would recovery the service undergoing, such as recovery from poor quality to normal or good quality. Specifically, under the retry mechanism, a retry action corresponding to the service failure event is triggered to allow the UE have communication service successfully. Under the recovery mechanism, a recovery action corresponding to the low QoS event is triggered to allow the UE to get back to a normal QoS state.

Trigging of an action can be achieved as follows. A correspondence relationship between event IDs and actions can be set in advance. Then according to the event ID received from the monitoring mechanism, an action corresponding to the event ID can be determined according to the correspondence relationship between event IDs and actions, then the action thus determined can be triggered to handle the communication abnormality event.

At block 407, when a preset condition is met, the handling mechanism will report the attribute information of the communication abnormality event to the prevention mechanism. For example, the preset condition can be defined as the handling mechanism fails to handle the communication abnormality event and the communication abnormality event occurs more than a preset number of times during a preset period. Specifically, when the retry mechanism fails to handle the service failure event, or when the recovery mechanism fails to handle the low QoS event, and the service failure event or the low QoS event occurs more than a threshold number of times during a period, then the failed result will be provided to the prevention mechanism. In response to the failed result received from the handling mechanism, the prevention mechanism will take actions to prevent issue from happening again if needed.

The retry mechanism, the recovery mechanism, and the prevention mechanism will be detailed below respectively.

Retry Mechanism

UE can have a retry action table for each service failure abnormality event, specifically, for each service failure event, defined like below in Table 3 as example:

TABLE 3

| | Event ID | Abnormality Event Name | Retry Action |
|---|---|---|---|
| 1 | 0x00001 | Cellar Service Lost (no | AP trigger PLMN |
| | | signal) | selection |
| 2 | 0x00002 | Couldn't get normal | AP trigger PLMN |
| | | service (network | selection |
| | | registration failed/ | |
| | | rejected) | |
| 3 | 0x00003 | Voice call setup failure | AP trigger re-dial |
| 4 | 0x00004 | Data call setup failure | AP trigger re-connect |
| 5 | 0x00005 | Voice call drop | AP trigger re-dial |
| 6 | 0x00006 | Data call drop | AP trigger re-connect |
| 7 | 0x00007 | SMS (text) sending failure | AP trigger re-send |
| 8 | 0x00008 | Supplemental service failure | AP trigger re-try |

Based on the event ID received from the abnormality monitoring mechanism for service failure event, UE would initiate a corresponding action to retry.

For example, if event 0x00003 (corresponding to voice call setup failure) is received, UE would trigger re-dial to see if it could succeed. Thus, UE does not report the voice call setup failure to the user immediately, in contrast, UE will retry first.

If the retry result is still failure and meet certain rules, UE can send the attribute information of the event such as the cell related information (Cell ID/RAT/PLMN etc.) to the prevention mechanism for further handling. The certain rule is timer and counter based, for example, the certain rule is that the retry failed more than a threshold number of times within a time period. Alternatively, the certain rule is counter based, and the certain rule may be that the retry failed more than a threshold number of times. Still possibly, the certain rule is timer based, and the certain rule may be that the retry last for a preset time period but still does not succeed. From another perspective, if the service failure event is reported every time the event occurs, the certain rule may be that the retry is failed and the service failure event has occurred for more than a preset number of times.

Recovery Mechanism

UE can have a recovery action table for each QoS event, defined like below in Table 4 as example:

TABLE 4

| | Event ID | QoS Event Name | Recovery Action |
|---|---|---|---|
| 1 | 0x10001 | Circuit switch (CS) voice | Assisted Handover |
| | | call poor quality | |
| 2 | 0x10002 | Packet switch (PS) voice | Assisted Handover |
| | | call poor quality | |
| 3 | 0x10003 | Data call low throughput | Assisted Handover/ |
| | | | RAT Change/Re-connect |
| 4 | 0x10004 | Data call long delay | Assisted Handover/ |
| | | | RAT Change/Re-connect |
| 5 | 0x10005 | Data call big jitter | Assisted Handover/ |
| | | | RAT Change/Re-connect |
| 6 | 0x10006 | Frequent service lost | RAT Change/Airplane |
| | | | mode |
| 7 | 0x10007 | Frequent network scanning | RAT Change/Airplane |
| | | | mode |

Based on the event ID received from the QoS Monitoring mechanism for low QoS event, UE would initiate corresponding action to recovery.

For example, if event 0x10001 (corresponding to CS voice call poor quality) is received, based on the call type (emergency or normal call), UE would trigger a related action to see if it could recovery the call.

If the recovery result is “failure” and meet certain rules, UE can send the attribute information of the event such as the cell related information (Cell ID/RAT/PLMN etc.) to the prevention mechanism for further handling. The certain rule is timer and counter based, for example, the certain rule is that the recovery failed more than a threshold number of times within a time period. Alternatively, the certain rule is counter based, and the certain rule may be that the recovery failed more than a threshold number of times. Still possibly, the certain rule is timer based, and the certain rule may be that the recovery last for a preset time period but still does not succeed. If the low QoS event is reported every time the event occurs, the certain rule may be that the recovery is failed and the low QoS event has occurred for more than a preset number of times.

Prevention Mechanism

A prevention mechanism can be designed to prevent repetitive failures or service degradation from happening.

After service failure events or low QoS events are detected by the monitoring mechanism and handled by the handling mechanism, as mentioned before, based on certain logic, UE can decide to trigger the prevention mechanism. The certain logic may be that, if the amount of events received regarding a cell/RAT is relatively large such as greater than a preset number, the cell/RAT can be degraded or added into a blacklist; if issues relating to IMS service occur frequently, the IMS service can be temporarily disabled.

Under the prevention mechanism, at least one of the following actions is triggered: adding the cell ID to a low priority cell list or blacklist such as a low priority cell/blacklist cell database; disabling temporally the concerning RAT such as the RAT currently used; and disabling temporally the concerning feature such as the PLMN currently communicated with.

Management of prevention actions can be timer/location based. Once certain timer/location based condition is met, the prevention action can be released. For instance, when a prevention action is triggered, a timer corresponding to the prevention action will be started, and the prevention action will be released when the timer expired. Alternatively, the prevention action may be location based. In this case, the prevention action will be reset if the UE is out of the problem area. For example, from the attribute information (such as location of the UE, cell ID, and the like) of the communication abnormality event received, the prevention mechanism can know the location of UE. When the location of the UE is changed, that is, when the location relating to the cell related information is changed, it is likely that the communication abnormality event will not occur again in the near future, therefore, the prevention action can be released.

The prevention action management can be achieved with databases. For example, UE can have several new databases to store the prevention action related data, see below as example:

TABLE 5

| | | | | Condition to |
|---|---|---|---|---|
| | Database | | | remove from |
| | Name | Content | Usage | database |
| 1 | Low Priority | PLMN/Cell | Lower the chance | Timer expired/ |
| | Cell | ID/RAT | UE reselect to | Location changed |
| | | | cells in it | |
| 2 | Blacklist | PLMN/Cell | Prohibit the | Timer expired/ |
| | Cell | ID/RAT | UE to (re)select | Location changed |
| | | | to Cells in it | |
| 3 | Disabled | PLMN/Cell | UE will not | Timer expired/ |
| | RAT | ID/RAT | enable the RAT | Location changed |
| 4 | Disabled | PLMN/Cell | UE will not | Timer expired/ |
| | Feature | ID/RAT/ | enable the | Location changed |
| | | Feature | feature | |

In Table 5 given above, four databases are provided and each of them corresponds to a different prevention strategy. In the database named “low priority cell”, priority of the PLMN/Cell ID/RAT will be lowered, therefore, the chance that UE reselects to cells relating to the PLMN/Cell ID/RAT will be decreased; therefore, the abnormality event can be prevented from happening again.

UE will check the above data during cell selection/reselection and feature/RAT enablement to see if it shall proceed or remove the restriction.

According to embodiments, a UE is provided. The UE includes at least one processor and a memory configured to store computer readable programs which, when executed by the at least one processor, are operable with the processor to perform the method for handling communication abnormality of FIG. 4. The at least one processor can be the application processor (AP) 12 of FIG. 1, the memory can be the memory 11 of FIG. 1. The memory is used to load and store data and/or instructions, for example, for the mechanisms. The memory may include any combination of suitable volatile memory, such as dynamic random access memory (DRAM)), and/or non-volatile memory, such as flash memory.

According to embodiments, a computer readable storage medium is provided. The computer readable storage medium stores a computer program which, when executed by a processor, causes the processor to perform the method for handling communication abnormality of FIG. 4.

A person having ordinary skill in the art understands that each of the mechanism, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the UE, mechanisms, and components in the above-mentioned embodiment since the working processes for a complete understanding of the disclosure. For easy description and simplicity, these working processes will not be repeated.

It is understood that the disclosed mechanisms, devices, and method in the embodiments of the present disclosure can be realized with other ways. The above-mentioned embodiments are exemplary only. The division of the components such as the detector, the abnormality processor, and the prevention controller is merely based on logical functions while other divisions exist in realization. It is possible that a plurality components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

What is claimed is:

1. A method for handling communication abnormality of a user equipment (UE), comprising:
detecting, by a monitoring mechanism of the UE, a communication abnormality event;
reporting the communication abnormality event together with attribute information of the communication abnormality event to a handling mechanism of the UE;
handling, by the handling mechanism, the communication abnormality event; and
reporting, by the handling mechanism, the attribute information to a prevention mechanism of the UE for preventing the communication abnormality event from happening again, when a preset condition is met.

2. The method of claim 1, further comprising:
determining an event ID corresponding to the communication abnormality event according to a correspondence relationship between communication abnormality events and event IDs, wherein each communication abnormality event has one unique event ID;
wherein reporting the communication abnormality event to the handling mechanism comprises:
reporting the event ID to the handling mechanism.

3. The method of claim 1, wherein handling, by the handling mechanism, the communication abnormality event comprises:
determining an action corresponding to the event ID according to a correspondence relationship between event IDs and actions; and
triggering the action to handle the communication abnormality event.

4. The method of claim 1, wherein the preset condition is:
the handling mechanism fails to handle the communication abnormality event and the communication abnormality event occurs more than a preset number of times during a preset period.

5. The method of claim 1, wherein the preset condition is:
the handling mechanism fails to handle the communication abnormality event within a preset period.

6. The method of claim 1, wherein the preset condition is:
the handling mechanism fails to handle the communication abnormality event after a preset number of attempts.

7. The method of claim 1, wherein the preset condition is:
the handling mechanism fails to handle the communication abnormality event after a preset number of attempts within a preset period.

8. The method of claim 1, wherein the attribute information comprises cell related information.

9. The method of claim 8, wherein the cell related information comprises at least one of: cell ID, a radio access technology (RAT) currently used, or a public land mobile network (PLMN) currently communicated with.

10. The method of claim 9, wherein in the prevention mechanism, at least one of the following actions is triggered: adding the cell ID to a low priority cell list or blacklist, disabling temporally the RAT currently used, or disabling temporally the PLMN currently communicated with.

11. The method of claim 10, wherein in the prevention mechanism, the action is released when a timer expired or when a location relating to the cell related information is changed.

12. The method of claim 8, wherein the attribute information further comprises at least one of time or location information of the communication abnormality event.

13. The method of claim 1, wherein reporting the communication abnormality event to the handling mechanism comprises:
reporting the communication abnormality event to the handling mechanism on condition that the communication abnormality event lasts for a preset time period.

14. The method of claim 1, wherein reporting the communication abnormality event to the handling mechanism comprises:
reporting the communication abnormality event to the handling mechanism on condition that the communication abnormality event occurs more than a preset number of times.

15. The method of claim 1, wherein the communication abnormality event is a service failure event.

16. The method of claim 15, wherein the handling mechanism is a retry mechanism, in which a retry action corresponding to the service failure event is triggered to allow the UE have communication service successfully.

17. The method of claim 1, wherein the communication abnormality event is a poor quality of service (QoS) event.

18. The method of claim 17, wherein the handling mechanism is a recovery mechanism, in which a recovery action corresponding to the low QoS event is triggered to allow the UE to get back to a normal QoS state.

19. A user equipment (UE), comprising a detector, an abnormality processor, and a prevention controller, wherein
the detector is configured to detect a communication abnormality event and report the communication abnormality event, together with attribute information of the communication abnormality event, to the abnormality processor;
the abnormality processor is configured to handle the communication abnormality event, and report the attribute information to the prevention controller when a preset condition is met; and
the prevention controller is configured to trigger a prevention action for preventing the communication abnormality event from happening again.

20. A non-transitory computer readable storage medium storing a computer program which, when executed by a processor of a user equipment (UE), causes the processor to:
detect, via a monitoring mechanism of the UE, a communication abnormality event;
report the communication abnormality event together with attribute information of the communication abnormality event to a handling mechanism of the UE;
handle, via the handling mechanism, the communication abnormality event; and
report, via the handling mechanism, the attribute information to a prevention mechanism of the UE for preventing the communication abnormality event from happening again, when a preset condition is met.
